(19) United States
(12) Patent Application Publication
(10) Pub. No.: US 2026/0098941 A1
(43) Pub. Date: Apr. 9, 2026

(54) OPTICAL RANGING MODULE AND ELECTRONIC DEVICE

(71) Applicant: Newmax Technology Co., Ltd., Taichung City (TW)

(72) Inventors: Yung-Fu LIANG, Taichung City (TW); Chiung-Hung CHEN, Taichung City (TW)

(21) Appl. No.: 19/017,386

(22) Filed: Jan. 10, 2025

(30) Foreign Application Priority Data
Oct. 7, 2024 (TW) 113138162

(51) Int. Cl. G01S 7/481; G02B 5/20

(52) U.S. Cl. CPC G01S 7/4813; G02B 5/208

(57) ABSTRACT

An optical ranging module includes an optical transmitting unit, an optical receiving unit, a supporting cap and an optical filter layer. The optical transmitting unit includes, in order from the object side to the element side: a first optical lens assembly and a light source. The optical receiving unit includes, in order from the object side to the element side: a second optical lens assembly and an optical sensor. The supporting cap includes two openings that penetrate from the object side to the element side. The first optical lens assembly and the second optical lens assembly are respectively disposed in the two openings. The optical filter layer is made of a material that only allows infrared light to pass through, and is disposed on a light transmitting path of the optical transmitting unit and/or on a light receiving path of the optical receiving unit.

This application claims the benefit of Taiwan Patent Application No. 113138162, filed on Oct. 7, 2024, which is hereby incorporated by reference for all purposes as if fully set forth herein.

### BACKGROUND

### Technical Field

The present disclosure relates to an optical ranging module, and in particular to an electronic device having an optical ranging module.

### Related Art

Time of Flight (ToF) is a method that uses a transmitter to continuously send light to a target object, and then uses an optical sensor to receive the light returned from the target object, so as to obtain the target distance by detecting the flight time (round-trip) of the light. Currently, three-dimensional cameras of electronic devices mainly use optical ranging modules having the ToF, which include an optical transmitting unit and an optical receiving unit.

However, the optical transmitting unit usually uses a Vertical Cavity Surface Emitting Laser (VCSEL) as the light source. The light band between the target object and the optical ranging module is not only infrared light, but may also include visible light and light of other band. Thus, when the signal-noise ratio is too low, the ranging errors are prone to occur.

On the other hand, due to the high reflectivity characteristics of the optical lens itself, white reflection will appear on the appearance of the optical ranging module after the optical ranging module is assembled, resulting in low color consistency.

Thus, an optical ranging module and an electronic device need to be provided for meeting previous requirements.

### SUMMARY

An objective of the present disclosure is to provide an optical ranging module, the optical filter layer is disposed on an object-side surface of a light transmitting unit and an object-side surface of an optical receiving unit; furthermore, the optical filter layer is used to filter out visible light, and the optical filter layer and the supporting cap have similar color, so as to improve the ranging accuracy and appearance color consistency of the optical ranging module.

To achieve the above objective, the present disclosure provides an optical ranging module, defining an object side and an element side opposite to the object side, the optical ranging module comprising: an optical transmitting unit comprising, in order from the object side to the element side: a first optical lens assembly and a light source; an optical receiving unit comprising, in order from the object side to the element side: a second optical lens assembly and an optical sensor; a supporting cap comprising two openings that penetrate from the object side to the element side, wherein the first optical lens assembly of the optical transmitting unit and the second optical lens assembly of the optical receiving unit are respectively disposed in the two openings; and an optical filter layer being made of a material that only allows infrared light to pass through, and disposed on a light transmitting path of the optical transmitting unit and/or on a light receiving path of the optical receiving unit.

The present disclosure further provides an electronic device, comprising: a housing; the above-mentioned optical ranging module disposed in the housing; a driving element disposed in the housing and electrically connected to the light source; and a control component disposed in the housing and electrically connected to the optical sensor.

According to the optical ranging module of the present disclosure, the optical filter layer can allow the infrared light to pass through, and the optical filter layer and the supporting cap have similar light reflectivity, thereby reducing glare and improving human vision comfort.

### BRIEF DESCRIPTION OF THE DRAWINGS

FIG. 1 is a schematic sectional view of an optical ranging module according to an embodiment of the present disclosure, showing that the optical filter layer is disposed on an object-side surface of the optical transmitting unit and an object-side surface of the optical receiving unit.

FIG. 1a is a schematic perspective view of the optical ranging module according to the first embodiment of the present disclosure.

FIG. 2 is a schematic sectional view of an optical ranging module according to the second embodiment of the present disclosure.

FIG. 3 is a schematic sectional view of an optical ranging module according to the third embodiment of the present disclosure.

FIG. 4 is a schematic diagram of the optical properties of an optical filter layer of the present disclosure.

FIG. 5 is a schematic sectional view of an electronic device according to another embodiment of the present disclosure.

### DETAILED DESCRIPTION

To make the foregoing objectives, characteristics and features of the present disclosure more comprehensible, preferred embodiments of the present disclosure are described in detail below with reference to the accompanying drawings.

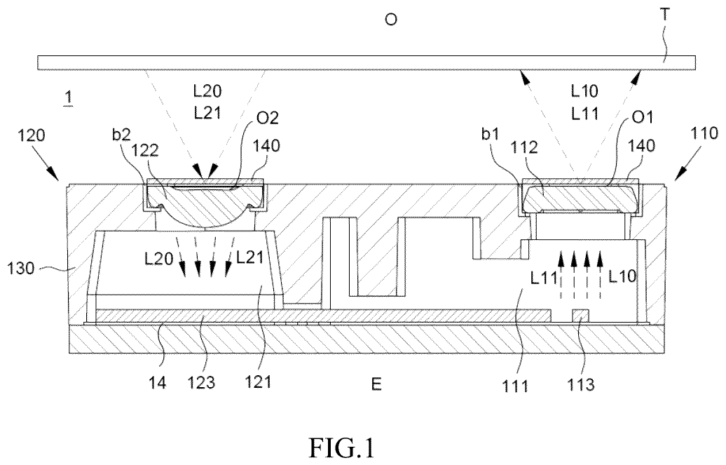

FIG. 1 is a schematic sectional view of an optical ranging module according to an embodiment of the present disclosure, showing that the optical filter layer is disposed on an object-side surface of the optical transmitting unit and an object-side surface of the optical receiving unit. FIG. 1a is a schematic perspective view of the optical ranging module according to the first embodiment of the present disclosure. Referring to FIG. 1 and FIG. 1a, the optical ranging module 1 defines an object side O and an element side E opposite to the object side O, and includes: an optical transmitting unit 110, an optical receiving unit 120, a supporting cap 130 and an optical filter layer 140.

The optical transmitting unit 110 has a first central axis a1 and a first lens barrel 111 surrounding the first central axis a1. The optical transmitting unit 110 includes, in order from the object side O to the element side E: a first optical lens assembly 112 and a light source 113 which are sequentially disposed in the first lens barrel 111. The first optical lens assembly 112 includes at least one optical lens. The light source 113 is an infrared light source that provides an infrared light toward the object side O. The light source 113 can be a Vertical Cavity Surface Emitting Laser (VCSEL), or an Edge Emitting Laser (EEL), but is not limited thereto.

The optical receiving unit 120 has a second central axis a2 and a second lens barrel 121 surrounding the second central axis a2. The optical receiving unit 120 includes, in order from the object side O to the element side E: a second optical lens assembly 122 and an optical sensor 123 which are sequentially disposed in the second lens barrel 121. The second optical lens assembly 122 includes at least one optical lens. The optical sensor 123 can be a photosensitive element for receiving the light that passes through the second optical lens assembly 122. The photosensitive element can be a Complementary Metal Oxide Semiconductor (CMOS) or a charge coupled device (CCD), but is not limited thereto.

The supporting cap 130 can be a shell. One surface S of the shell is a plane. The supporting cap 130 includes a first opening b1 and a second opening b2 that can penetrate from the object side O to the element side E. The first optical lens assembly 112 of the optical transmitting unit 110 is disposed in the first opening b1, and an object-side surface of the first optical lens assembly 112 of the optical transmitting unit 110 and the first opening b1 both face the object side O. The light L10 of the light source 113 passes through the first optical lens assembly 112 and then travels to the object side O through the first opening b1. The second optical lens assembly 122 of the optical receiving unit 120 is disposed in the second opening b2, and the object-side surface of the second optical lens assembly 122 of the optical receiving unit 120 and the second opening b2 both face the object side O. The optical sensor 123 receives the light L20 from the object side O and passes through the second optical lens assembly 122. The supporting cap 130 can be made of black plastic material, which has low optical reflectivity and is not easy to produce glare. The preferred optical reflectivity of the supporting cap 130 is generally between 2% and 5%.

The optical ranging module 1 further includes a base 14, the light source 113 is disposed on the base 14, and the optical sensor 123 is disposed on the base 14. The supporting cap 130 is disposed on the base 14 and defines first and second accommodation spaces between the supporting cap 130 and the base 14 for respectively accommodating the optical transmitting unit 110 and the optical receiving unit 120.

The optical filter layer 140 is made of a material that only allows infrared light to pass through, such as an ink that can allows infrared light to pass through (called as IR Ink) (for example, the supplier of the IR Ink can be: Shenzhen Miramar Technology Co., Ltd., ink model: MT-IR-2381J), and is disposed on a light transmitting path L11 of the optical transmitting unit 110 and/or a light receiving path L21 of the optical receiving unit 120. In this embodiment, the light transmitting path L11 refers to the path that the light L10 is emitted by the light source 113, passes through the first optical lens assembly 112, and then passes through the optical filter layer 140 to a target object T; and the light receiving path L21 refers to the path that the light L20 is reflected by the target object T, passes through the optical filter layer 140, and then passes through the second optical lens assembly 122 to the optical sensor 123. The optical filter layer 140 can be disposed on the object-side surface O1 of the first optical lens assembly 112 of the optical transmitting unit 110, or on the object-side surface O2 of the second optical lens assembly 122 of the optical receiving unit 120, or simultaneously on the object-side surface O1 of the optical transmitting unit 110 and the object-side surface O2 of the optical receiving unit 120. In this embodiment, the optical filter layer 140 is disposed on both the object-side surface O1 of the optical transmitting unit 110 and the object-side surface O2 of the optical receiving unit 120 simultaneously. The optical filter layer 140 is used for filtering out visible light having a wavelength between 360 nm and 830 nm. The optical filter layer 140 and the supporting cap 130 have similar color or same color that is visible to human eyes, such as black, but are not limited to thereto. After the optical ranging module 1 is assembled, the optical filter layer 140 and the supporting cap 130 can have consistent visual effects. In addition, the optical filter layer 140 and the supporting cap 130 have similar light reflectivity, such as 2% to 5%, but not limited thereto, thereby reducing glare and improving visual comfort.

Referring to FIG. 1 again, in this embodiment, a target object T is located on the object side O of the optical ranging module 1. When the optical filter layer 140 is simultaneously disposed between the target object T and the optical transmitting unit 110 and between the target object T and the optical receiving unit 120, the light source 113 of the optical transmitting unit 110 transmits a light L10 along the light transmitting path L11, the light L10 passes through the first optical lens assembly112, and then the light L10 passes through the optical filter layer 140 and is projected to the target object T. A light L20 is reflected from the target object T. The light L20 passes through the optical filter layer 140 along the light receiving path L21, then the light L20 passes through the second optical lens assembly 122, and the light L20 is finally received by the optical sensor 123. In another embodiment, a target object T is located on the object side O of the optical ranging module 1. When the optical filter layer 140 is only located between the target object T and the optical transmitting unit 110. The light source 113 of the optical transmitting unit 110 transmits a light L10. The light L10 passes through the first optical lens assembly 112 along the light transmitting path L11, and then the light L10 passes through the optical filter layer 140 and is projected to the target object T. A light L20 is reflected from the target object T. The light L20 passes through the second optical lens assembly 122 along the light receiving path L21, and the light L20 is finally received by the optical sensor 123. In a further embodiment, a target object T is located on the object side O of the optical ranging module 1. When the optical filter layer 140 is only located between the target T and the optical receiving unit 120, the light source 113 of the optical transmitting unit 110 transmits a light L10 along the light transmitting path L11. The light L10 passes through the first optical lens assembly 112, and is projected to the target object T. A light L20 is reflected from the target object T. The light L20 passes through the optical filter layer 140 along the light receiving path L21, then the light L20 passes through the second optical lens assembly 122, and the light L20 is finally received by the optical sensor 123.

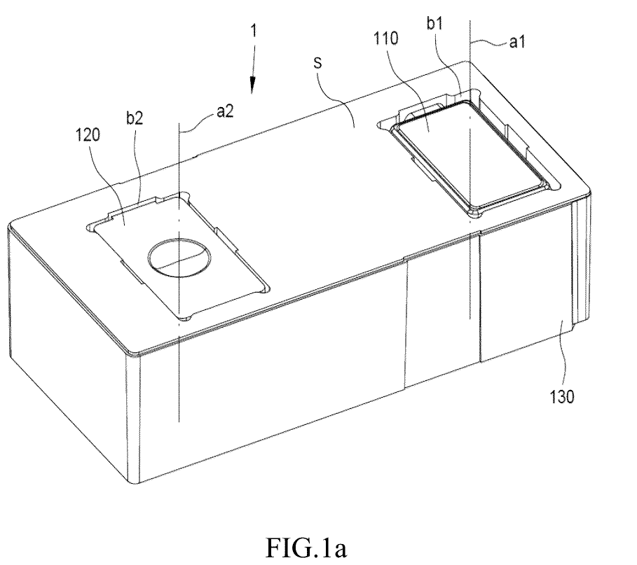

FIG. 2 is a schematic sectional view of an optical ranging module according to the second embodiment of the present disclosure. Referring to FIG. 2, the difference between the first and second embodiments is that: the optical ranging module 2 in the second embodiment defines an object side O and an element side E opposite to the object side O, and includes: an optical transmitting unit 210, an optical receiving unit 220, a supporting cap 230, an optical filter layer 240 and a transparent cover 250 (such as protective glass sheet or cover glass sheet). The optical filter layer 240 can be located on an object-side surface O3 or an element-side surface O4 of the transparent cover 250. The transparent cover 250 can be located on one side of the first optical lens assembly 212 of the light transmitting unit 210 toward the object side O, or the transparent cover 250 can be located on the other side of the first optical lens assembly 212 of the light transmitting unit 210 toward the element side E. The transparent cover 250 can be located on the one side of the second optical lens assembly 222 of the optical receiving unit 220 toward the object side O, or the transparent cover 250 can be located on the other side of the second optical lens assembly 222 of the optical receiving unit 220 toward the element side E. The optical filter layer 240 can also be disposed on the object-side surface O1 of the first optical lens assembly 212 of the optical transmitting unit 210 or the object-side surface O2 of the second optical lens assembly 222 of the optical receiving unit 220. In this embodiment, the optical filter layer 240 is located on the object-side surface O3 of the transparent cover 250, and the transparent cover 250 is located on one side of the first optical lens group 212 of the light-emitting unit 210 toward the object side O. When the transparent cover 250 and the optical filter layer 240 are disposed on the light transmitting path L11 of the optical transmitting unit 210 or the light receiving path L21 of the optical receiving unit 220, the optical performance of the optical transmitting unit 210 or the optical receiving unit 220 can be improved by the transparent cover 250 and the optical filter layer 240. When the transparent cover 250 and the optical filter layer 240 are used as window covers, they have dust-proof and anti-pollution functions.

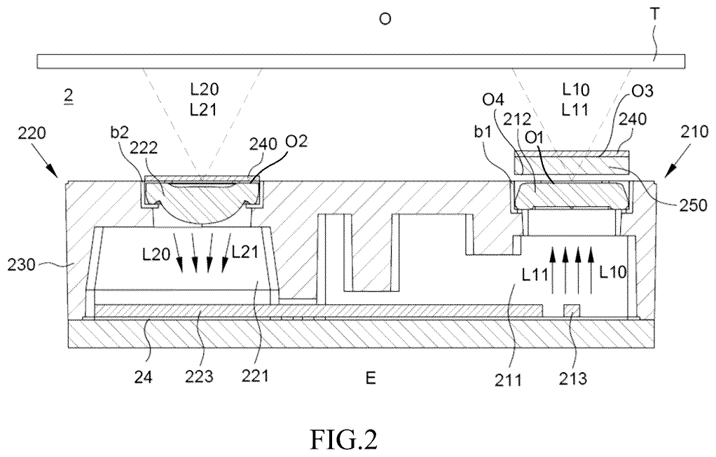

FIG. 3 is a schematic sectional view of an optical ranging module according to the third embodiment of the present disclosure. Referring to FIG. 3, the difference between the first and third embodiments is that: the optical ranging module 3 in the third embodiment defines an object side O and an element side E opposite to the object side O, and includes: an optical transmitting unit 310, an optical receiving unit 320, a supporting cap 330, an optical filter layer 340 and a transparent cover 350 (such as two protective glass sheets or cover glass sheets). The optical filter layer 340 is located on an object-side surface O3 or the element-side surface O4 of the transparent cover 350. The transparent cover 350 can be located on one side of the first optical lens assembly 312 of the light transmitting unit 310 toward the object side O, or the transparent cover 350 can be located on the other side of the first optical lens assembly 312 of the light transmitting unit 310 toward the element side E. The transparent cover 350 can be located on one side of the second optical lens assembly 322 of the receiving unit 320 toward the object side O, or the transparent cover 350 can be located on the other side of the second optical lens assembly 322 of the receiving unit 320 toward the element side E. In this embodiment, the optical filter layer 340 is located on the object-side surface O3 of the transparent cover 350, and the transparent cover 350 is located on one side of the first optical lens assembly 312 of the light transmitting unit 310 toward the object side O, and the the transparent cover 350 is also located on the side of the second optical lens assembly 322 of the optical receiving unit 320 toward the object side O.

In other embodiment, the transparent cover 350 can be two protective glass sheets that are integrally formed and located simultaneously on one side of the optical transmitting unit 310 toward the object side O and one side of the optical receiving unit 320 toward the object side O; or, the transparent cover 350 can be two protective glass sheets that are integrally formed and located simultaneously on one side of the optical transmitting unit 310 toward the element-side E and one side of the optical receiving unit 320 toward the element-side E. The two integrally formed protective glass sheets (i.e., the transparent cover 350) can improve the assembly accuracy of the optical ranging module 1. In this embodiment, it can also be two separate protective glass sheets (i.e., the transparent cover 350) respectively located on one side of the optical transmitting unit 310 toward the object side O and one side of the optical receiving unit 320 toward the object side O. The function of the two separate protective glass sheets (i.e., the transparent cover 350) is that: when the optical transmitting unit 310 or the optical receiving unit 320 is defective, the assembly yield of the optical ranging module 1 is improved.

In detail, the optical filter layer 140, 240, 340 in the above-mentioned optical ranging module can be made of an ink material (i.e., IR Ink) that allows the infrared light to pass through, such as black ink. The IR Ink is formed on the object-side surface of the lens of the first optical lens assembly 112, 212, 312 that is the closest to the object side, the IR Ink is formed on the object-side surface of the lens of the second optical lens group 122, 222, 322 that is the closest to the object side, or the IR Ink is formed on the object-side surface of the transparent cover 250, 350. The optical filter layer has a thickness of no more than 50 μm. Since the curvature radius of the lens and the object-side surface of the transparent cover may be different, and the uniformity of the coated ink is considered, preferably, the thickness of the coated ink can be between 5 μm and 10 μm, and the coating process can be selected from the group consisting of a pad printing process, a screen printing process or a spraying process.

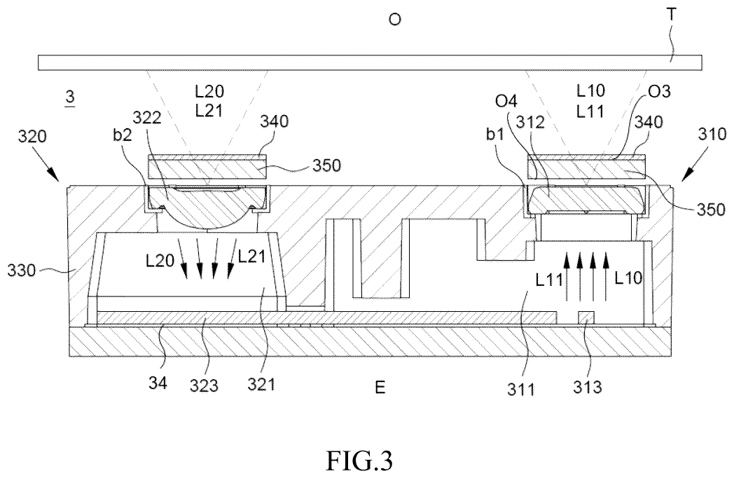

FIG. 4 is a schematic diagram of the optical properties of an optical filter layer of the present disclosure. The material properties of the optical filter layer are that: the human eye can experience black vision in the visible light range, and in the near-infrared band above 800nm, the transmittance of the infrared light can be selected between 85% and 90% based on the thickness, working band and color requirements of the coated ink, but is not limited to thereto.

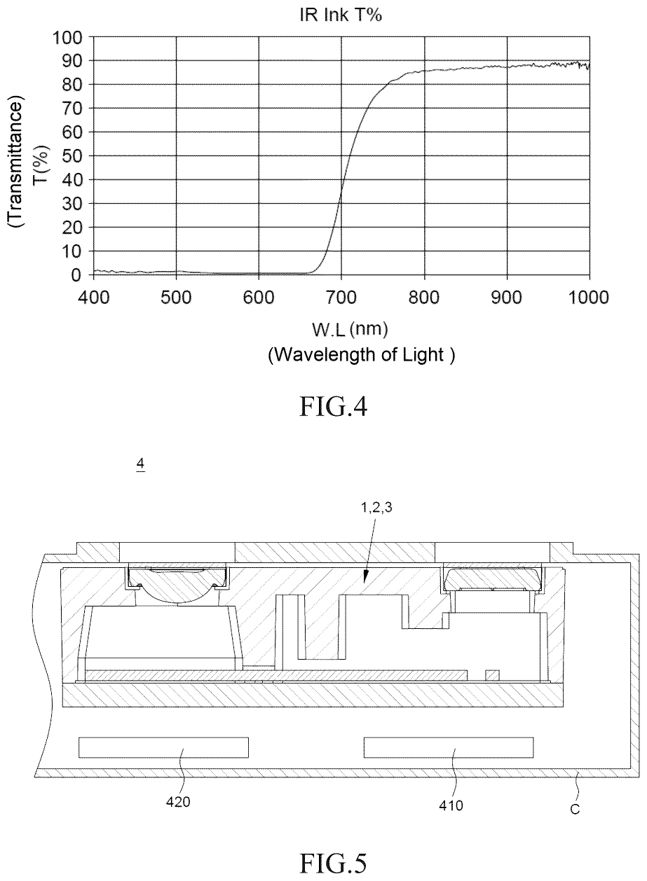

FIG. 5 is a schematic sectional view of an electronic device according to another embodiment of the present disclosure. The electronic device 4 is, for example, a smart phone. The electronic device 4 includes a housing C, the optical ranging modules 1, 2, 3, a driving element and a control component. The optical ranging modules 1, 2, and 3 are disposed in the housing C. The driving element 410 is disposed in the housing C and is electrically connected to the light sources 113, 213, 313. The control component 420 are disposed in the housing C and are electrically connected to the optical sensors 123, 223, 323.

The optical ranging module 1 of the present disclosure can be used in optical systems, and can be used in various aspects such as facial recognition of 3D (three-dimensional) image capture, automatic focusing or depth sensing shooting function of consumer electronic products, the tracking user movements of virtual reality (VR) and augmented reality (AR), autonomous driving and driver assistance systems (ADAS) or gesture control in the automotive industry, positioning in robots and industrial automation, navigation on object recognition and real-time distance measurement by drone.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. An optical ranging module, defining an object side and an element side opposite to the object side, the optical ranging module comprising:
an optical transmitting unit comprising, in order from the object side to the element side: a first optical lens assembly and a light source;
an optical receiving unit comprising, in order from the object side to the element side: a second optical lens assembly and an optical sensor;
a supporting cap comprising two openings that penetrate from the object side to the element side, wherein the first optical lens assembly of the optical transmitting unit and the second optical lens assembly of the optical receiving unit are respectively disposed in the two openings; and
an optical filter layer being made of a material that only allows infrared light to pass through, and disposed on a light transmitting path of the optical transmitting unit and/or on a light receiving path of the optical receiving unit.

2. The optical ranging module according to claim 1, wherein the optical filter layer is disposed on an object-side surface of the first optical lens assembly of the optical transmitting unit and/or an object-side surface of the second optical lens assembly of the optical receiving unit, the optical filter layer is used for filtering out visible light, and the optical filter layer and the supporting cap have similar color.

3. The optical ranging module according to claim 2, wherein the optical filter layer is disposed on an object-side surface of a lens of the first optical lens assembly that is the closest to the object side, and the optical filter layer is disposed on an object-side surface of a lens of the second optical lens assembly that is the closest to the object side.

4. The optical ranging module according to claim 1, further comprising a transparent cover located on one side of the first optical lens assembly of the optical transmitting unit toward one of the object side and the element side or/and one side of the second optical lens assembly of the optical receiving unit toward one of the object side or the element side, wherein the optical filter layer is disposed on one of an object-side surface or an element-side surface of the transparent cover.

5. The optical ranging module according to claim 4, wherein the transparent cover is made of two protective glass sheets, and the optical filter layer is disposed on one of the object-side surface and the element-side surface of the transparent cover.

6. The optical ranging module according to claim 5, wherein when the two protective glass sheets are located respectively on one side of the first optical lens assembly toward the object side and on one side of the second optical lens assembly toward the object side, the two protective glass sheets are integrally formed.

7. The optical ranging module according to claim 5, wherein when the two protective glass sheets are located respectively on one side of the first optical lens assembly toward the element side and on one side of the second optical lens assembly toward the element side, the two protective glass sheets are integrally formed.

8. The optical ranging module according to claim 1, further comprising a transparent cover located on one side of the first optical lens assembly of the optical transmitting unit toward one of the object side and the element side, wherein the optical filter layer is disposed on the object-side surface or the element-side surface of the transparent cover, and the optical filter layer is also disposed on an object-side surface of the second optical lens assembly of the optical receiving unit.

9. The optical ranging module according to claim 1, further comprising a transparent cover located on one side of the second optical lens assembly of the optical receiving unit toward one of the object side and the element side, wherein the optical filter layer is disposed on the object-side surface or the element-side surface of the transparent cover, and the optical filter layer is also disposed on an object-side surface of the first optical lens assembly of the optical transmitting unit.

10. The optical ranging module according to claim 5, wherein the optical filter layer and the supporting cap have an optical reflectivity of less than 5%.

11. The optical ranging module according to claim 5, wherein the optical filter layer is made of black ink and has a thickness of no more than 50 μm.

12. An electronic device, comprising:
a housing;
an optical ranging module disposed in the housing, wherein:
the optical ranging module defines an object side and an element side opposite to the object side, and comprises:
an optical transmitting unit comprising, in order from the object side to the element side: a first optical lens assembly and a light source;
an optical receiving unit comprising, in order from the object side to the element side: a second optical lens assembly and an optical sensor;
a supporting cap comprising two openings that penetrate from the object side to the element side, wherein the first optical lens assembly of the optical transmitting unit and the second optical lens assembly of the optical receiving unit are respectively disposed in the two openings; and
an optical filter layer being made of a material that only allows infrared light to pass through, and disposed on a light transmitting path of the optical transmitting unit and/or on a light receiving path of the optical receiving unit;
a driving element disposed in the housing and electrically connected to the light source;
and
a control component disposed in the housing and electrically connected to the optical sensor.

13. The electronic device according to claim 12, wherein the optical filter layer is disposed on an object-side surface of the first optical lens assembly of the optical transmitting unit and/or an object-side surface of the second optical lens assembly of the optical receiving unit, the optical filter layer is used for filtering out visible light, and the optical filter layer and the supporting cap have similar color.

14. The electronic device according to claim 13, wherein the optical filter layer is disposed on an object-side surface of a lens of the first optical lens assembly that is the closest to the object side, and the optical filter layer is disposed on an object-side surface of a lens of the second optical lens assembly that is the closest to the object side.

15. The electronic device according to claim 12, further comprising a transparent cover located on one side of the first optical lens assembly of the optical transmitting unit toward one of the object side and the element side or/and one side of the second optical lens assembly of the optical receiving unit toward one of the object side or the element side, wherein the optical filter layer is disposed on one of an object-side surface or an element-side surface of the transparent cover.

16. The electronic device according to claim 15, wherein the transparent cover is made of two protective glass sheets, and the optical filter layer is disposed on one of the object-side surface and the element-side surface of the transparent cover.

17. The electronic device according to claim 16, wherein when the two protective glass sheets are located respectively on one side of the first optical lens assembly toward the object side and on one side of the second optical lens assembly toward the object side, the two protective glass sheets are integrally formed.

18. The electronic device according to claim 16, wherein when the two protective glass sheets are located respectively on one side of the first optical lens assembly toward the element side and on one side of the second optical lens assembly toward the element side, the two protective glass sheets are integrally formed.

19. The electronic device according to claim 12, further comprising a transparent cover located on one side of the first optical lens assembly of the optical transmitting unit toward one of the object side and the element side, wherein the optical filter layer is disposed on the object-side surface or the element-side surface of the transparent cover, and the optical filter layer is also disposed on an object-side surface of the second optical lens assembly of the optical receiving unit.

20. The electronic device according to claim 12, further comprising a transparent cover located on one side of the second optical lens assembly of the optical receiving unit toward one of the object side and the element side, wherein the optical filter layer is disposed on the object-side surface or the element-side surface of the transparent cover, and the optical filter layer is also disposed on an object-side surface of the first optical lens assembly of the optical transmitting unit.
